(19) United States
(12) Patent Application Publication
(10) Pub. No.: US 2006/0114491 A1
(43) Pub. Date: Jun. 1, 2006

(54) Image forming device, controlling method thereof, and recording material storage medium

(76) Inventors: Hyuck Kim, Seongnam-si (KR); Myung-song Jung, Gunpo-si (KR)

Correspondence Address: STANZIONE & KIM, LLP, 919 18TH STREET, N.W., SUITE 440, WASHINGTON, DC, 20006, US

(21) Appl. No.: 11/290,552

(22) Filed: Dec. 1, 2005

(30) Foreign Application Priority Data
Dec. 1, 2004 (KR) 2004-99716

(51) Int. Cl. G06K 15/00

(52) U.S. Cl. 358/1.14

(57) ABSTRACT

An image forming device, a controlling method thereof, and a recording material storage medium. The image forming device includes a customer replaceable unit memory (CRUM) provided to a recording material storage medium thereof to store a toner shortage indicator that is set to “Low” to indicate a recording material shortage if a remaining amount of the recording material in the recording material storage medium is not greater than a predetermined threshold, and a controller to determine that the recording material storage medium is refilled with the recording material by a non-authentic method if the remaining quantity of the recording material in the recording material storage medium is greater than the predetermined threshold and if the toner shortage indicator is set to “Low” to indicate the recording material shortage. Accordingly, a user can be encouraged to use an authentic recording material for refills.

### CROSS-REFERENCE TO RELATED APPLICATIONS

This application claims benefit under 35 U.S.C. § 119 from Korean Patent Application No. 2004-99716, filed on Dec. 1, 2004, the disclosure of which is incorporated herein in its entirety by reference.

### BACKGROUND OF THE INVENTION

1. Field of the Invention

The present general inventive concept relates to an image forming device, a controlling method thereof and a recording material storage medium installed in the image forming device, and more particularly, to a recording material storage medium provided with a customer replaceable unit memory (CRUM), an image forming device and a controlling method thereof.

2. Description of the Related Art

Image forming devices form (i.e., print) images corresponding to original input image data on recording media, such as printing paper. Typical examples of the image forming device are printers, copiers, fax machines, etc.

The image forming device uses toner as a recording material, and toner cartridges and ink cartridges are generally used as a storage medium for the recording material. Because the recording material storage medium is usually expensive, when the recording material (i.e., toner) is used up, many users prefer refilling the recording material in the recording material storage medium to purchasing a new toner (or ink) cartridge.

When refilling the recording material, a user should be careful to choose an authenticated refill station. That is, if the refill station is authenticated or authorized by the manufacturer of the recording material storage medium, the quality of the recording material is assured. Unfortunately however, if a user, for the sake of saving money, chooses other service stations that are neither authenticated nor authorized by the manufacturer of the recording material storage medium, the print quality can be degenerated.

Since the cartridge refilling is not done properly by an authenticated service agency, an image forming device can get out of order. However, this problem may not be self-evident to a service engineer of the image forming device.

### SUMMARY OF THE INVENTION

The present general inventive concept provides an image forming device, a controlling method thereof, and a recording material storage medium provided with a customer replaceable unit memory (CRUM), in which every time a recording material is refilled in the recording material storage medium, refill information regarding various types of recording materials can be stored in the CRUM to effectively manage the recording material storage medium.

The present general inventive concept also provides an image forming device, a controlling method thereof, and a recording material storage medium provided with a customer replaceable unit memory (CRUM), in which a toner (or ink) shortage indicator stored in the CRUM determines whether a recording material is refilled properly or non-properly, thereby encouraging a user to refill the recording material by using an authenticated refill method.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing an image forming device to form an image using a recording material stored in a recording material storage medium, the device including a customer replaceable unit memory (CRUM) provided to the recording material storage medium to store a toner shortage indicator that is set to “Low” to indicate a recording material shortage if a remaining quantity of the recording material in the recording material storage medium is not greater than a predetermined threshold, and a controller to determine that the recording material storage medium is refilled by a non-authentic method if the remaining quantity of the recording material in the recording material storage medium is greater than the predetermined threshold and the toner shortage indicator is set to “Low” to indicate the recording material shortage.

The controller can control information regarding a non-authentic refill to be stored in the CRUM when the controller determines that the recording material storage medium is refilled by the non-authentic method.

The device may further include a residual recording material checking unit to check the remaining quantity of the recording material in the recording material storage medium, wherein the controller controls information regarding the remaining quantity of the recording material to be stored in the CRUM based on the checking result.

The device may further include an input unit to input a residual recording material check command, wherein when the residual recoding material check command is input, the controller reads the information regarding the remaining amount of the recording material from the CRUM.

The controller may read the information regarding the remaining amount of the recording material from the CRUM at predetermined time intervals.

The device may further include a first display unit, wherein if the toner shortage indicator is set to “Low” to indicate the recording material shortage and the remaining quantity of the recording material in the recording material storage medium is greater than the predetermines threshold, the controller controls at least one of a normal refill request message and an abnormal refill notification message to be displayed on the first display unit.

The foregoing and/or other aspects of the present general inventive concept may also be achieved by providing an image forming device, including a refillable recording material storage medium to store a recording material and having a customer replaceable unit memory (CRUM) to store an amount of the recording material remaining in the recording material storage medium and an indicator to indicate a shortage in the amount of the recording material remaining in the storage medium, and an authenticity determination unit to determine whether the recording material storage medium has been refilled using an authentic process based on the amount of the recording material in the recording material storage medium and the indicator.

The foregoing and/or other aspects of the present general inventive concept may also be achieved by providing a recording material storage medium refillable with a recording material through a recording material refill device after a pre-stored recording material is exhausted, the recording material storage medium including a storage to store the recording material, and a customer replaceable unit memory (CRUM) to store recording material refill information about a recording material refilling process thereof.

The recording material refill information may include at least one of a refill count, a refill date, an amount of the refilled recording material, a product name of the refilled recording material, a product ID of the refilled recording material, a refill station ID (if the refilling process is executed at a recording material refill station), and an engineer ID at the refill station.

The CRUM may further store a toner shortage indicator that is set to “Low” if a residual amount of the recording material is less than a predetermined threshold, and a time and a date of checking the toner shortage wherein the recording material refill device initializes the toner shortage indicator such that the toner shortage indicator is no longer set to “Low” when the recording material refilling process is completed.

The foregoing and/or other aspects of the present general inventive concept may also be achieved by providing a refillable recording material storage medium usable with an image forming device to store a recording material, the refillable recording material storage medium including a customer replaceable unit memory (CRUM) to store a recording material shortage indicator to indicate a shortage of the recording material in the recording material storage medium and to be reset when the recording material storage medium is refilled using an authentic method.

The foregoing and/or other aspects of the present general inventive concept may also be achieve by providing a recording material refill device to refill a recording material storage medium with a recording material, the recording material refill device including a recording material refill management program to generate recording material refill data, an interface to transmit the recording material refill data to the recording material storage medium to be stored in a customer replaceable unit memory (CRUM) of the recording material storage medium, and a controller to reset a recording material shortage indicator stored in the CRUM such that the recording material shortage indicator no longer indicates a shortage of the recording material in the recording material storage medium.

The foregoing and/or other aspects of the present general inventive concept are achieved by providing a controlling method of an image forming device using a recording material stored in a recording material storage medium, the method including checking a residual amount of the recording material in the recording material storage medium, if the residual amount of the recording material is greater than a predetermined threshold, determining whether a toner shortage indicator stored in a customer replaceable unit memory (CRUM) of the recording material storage medium is set to “Low” to indicate a recording material shortage, and if the toner shortage indicator is set to “Low” to indicate the recording material shortage and the residual amount of the recording material is greater than the predetermined threshold, determining that the recording material storage medium is refilled with the recording material by a non-authentic method.

The method may further include storing information regarding the checked residual amount of the recording material in the CRUM.

The method may further include if the toner shortage indicator is set to “Low” to indicate the recording material shortage and the residual amount of the recording material is greater than the predetermined threshold, displaying at least one of a normal refill request message and an abnormal refill notification message.

The foregoing and/or other aspects of the present general inventive concept may also be achieved by providing a method of controlling an image forming device, including storing information regarding an amount of recording material remaining in a recording material storage medium of the image forming device in a customer replaceable unit memory (CRUM), and determining whether the recording material storage medium has been refilled using an authentic process based on the stored information regarding the amount of the recording material remaining in the recording material storage medium and a recording material shortage indicator stored in the CRUM.

The foregoing and/or other aspects of the present general inventive concept may also be achieved by providing a method of refilling a recording material storage medium usable with an image forming device, the method including filling a storage area of the recording material storage medium with a recording material, transmitting recording material refill information to the recording material storage medium to be stored in a customer replaceable unit memory (CRUM) of the recording material storage medium, and initializing a recording material shortage indicator stored in the CRUM such the recording material shortage indicator does no longer indicates a shortage of the recording material in the recording material storage medium.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic block diagram illustrating a recording material storage medium and a recording material refill device according to an embodiment of the present general inventive concept;

FIG. 2 is a schematic block diagram illustrating a printer according to an embodiment of the present general inventive concept;

FIG. 3 is a flow chart illustrating a method of storing recording material refill information according to an embodiment of the present general inventive concept; and

FIG. 4 is a flow chart illustrating a method of managing recording material refill information according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

Throughout the description, a printer represents an image forming device of the present general inventive concept, but the scope of the present general inventive concept is not to be limited thereto.

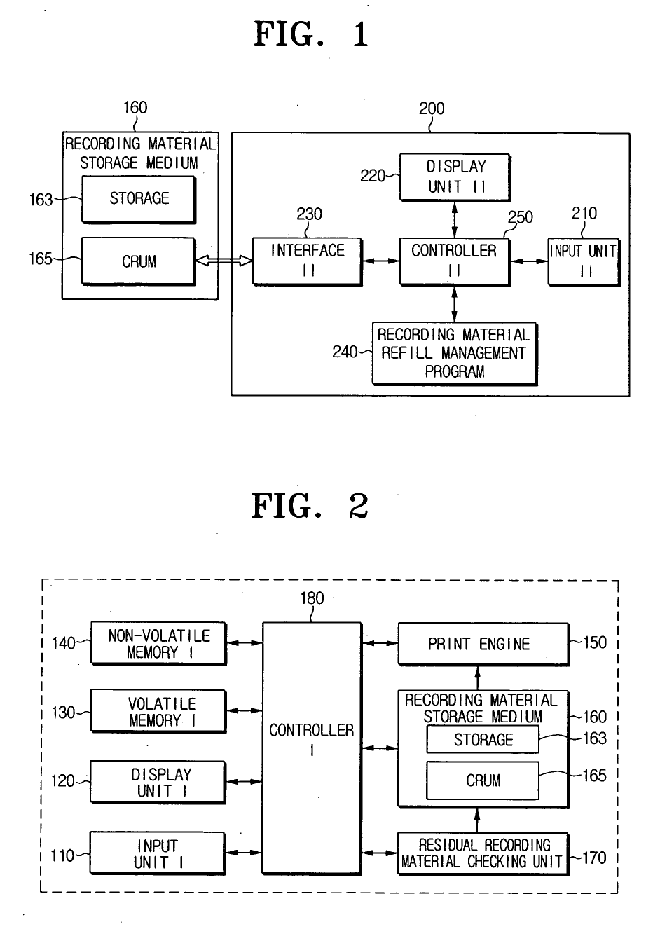

FIG. 1 is a schematic block diagram illustrating a recording material storage medium 160 and a recording material refill device 200 according to an embodiment of the present general inventive concept. As illustrated in FIG. 1, a recording material refill process can be performed on the recording material storage medium 160 through the recording material refill device 200.

Referring to FIG. 1, the recording material storage medium 160 has a storage 163, in which a recording material to print a document onto printing paper is stored. The recording material can be toner, and the recording material storage medium 160 can be a toner cartridge.

In a case in which the recording material storage medium 160 is usable with a black printer, the printer only uses a recording material of one color, so one recording material storage medium 160 installed in the printer is sufficient to print documents.

A color printer can also use one recording material storage medium 160. However, in this case, the storage 163 of the recording material storage medium 160 is divided into a plurality of partitioned spaces to store recording materials of different colors. On the other hand, the color printer can use a plurality of recording material storage mediums 160 to respectively store the recording materials of the different colors.

As illustrated in FIG. 1, a customer replaceable unit memory (CRUM) 165 is provided at a designated portion of the recording material storage medium 160.

The CRUM 165 can store information regarding residual quantity of the recording material in the storage 163, a number of printed pages, a printer model name, a printer serial number, information on customer replaceable units applied to the printer, and control programs of the customer replaceable units.

According to this embodiment of the present general inventive concept, the CRUM 165 stores recording material refill information. The recording material refill information includes information about the recording material refill process when the recording material is exhausted, and the recording material storage medium 160 (i.e., a toner cartridge) is refilled with the recording material at a refill station or by a user himself. For example, the recording material refill information can include a refill count, a refill date, an amount of the refilled recording material, a product name or a product ID of the refilled recording material, a refill station ID (if the recording material refill process is executed in a recording material refill station), an engineer ID at the refill station, etc.

The recording material refill information is generated by the recording material refill device 200 when the recording material refill process is completed or during the recording material refill process, and the generated information is transmitted to the recording material storage medium 160 and stored in the CRUM 165.

The recording material refill device 200 can include a second input unit (input unit II) 210, a second display unit (display unit II) 220, a second interface (interface II) 230, a recording material refill management program 240, and a second controller (controller II) 250.

The second input unit 210 can include at least one operation button to allow a user to input desired commands. A user command signal input through the second input unit 210 is provided to the second controller 250, and the second controller 250 controls the recording material refill device 200 in response to the input user command signal.

The second input unit 210 can also input a driving command of the recording material refill management program 240. Furthermore, the second input unit 210 can input the recording material refill information. The process of inputting the recording material refill information through the second input unit 210 can be realized using a GUI (Graphic User Interface) of the recording material refill management program 240, but the scope of the present general inventive concept is not limited thereto. The recording material refill information can also be generated automatically by the recording material refill management program 240.

The second display unit 220 displays user notification messages in response to a user command or under the control of the second controller 250.

The second interface 230 interfaces the recording refill device 200 and the recording material storage medium 160, and transmits data to the CRUM 165 of the recording material storage medium 160. When the recording material refill information is input to the recording material refill device 200 or generated automatically, the recording material refill information is transmitted to the CRUM 165 of the recording material storage medium 160 through the second interface 230.

The recording material refill management program 240 is an application program stored in a non-volatile memory (not shown) of the recording material refill device 200 to perform the recording material refilling process. The recording material refill management program 240 can provide the GUI such that the recording material refill information can be input therethrough.

The second controller 250 controls the recording material refilling process of the recording material refill device 200 by controlling the recording material refill management program 240 stored in the non-volatile memory (not shown) of the recording material refill device 200.

When the driving command of the recording material refill management program 240 is input, the recording material refill management program 240 is driven under the control of the second controller 250.

When the recording material refill information is input, the second controller 250 controls the second interface 230 to transmit the recording material refill information to the recording material storage medium 160 to be stored in the CRUM 165. Alternatively, the recording material refill information can be generated automatically through the recording material refill management program 240, and transmitted to the recording material storage medium 160 to be stored in the CRUM 265 under the control of the second controller 250.

If a toner shortage indicator stored in a predetermined storage of the CRUM 165 is set to “Low” (meaning that the recording material is going to run out) at the end of the recording material refilling process, the second controller 250 starts an initialization process. In the initialization process, the toner shortage indicator is reset to no longer be set to “Low”. The toner shortage indicator to indicate a status of the recording material remaining in the storage 163 of the recording material storage medium 163 is set to “Low” again when a residual quantity of the recording material refilled in the storage 163 of the recording material storage medium 160 is less than a predetermined threshold.

FIG. 2 is a schematic block diagram illustrating a printer according to an embodiment of the present general inventive concept.

Referring to FIGS. 1 and 2, the printer 100 can a first input unit (input unit I) 110, a first display unit 120, a first volatile memory (volatile memory I) 130, a first non-volatile memory (non-volatile memory I) 140, a print engine 150, the recording material storage medium 160, a residual recording material checking unit 170, and a first controller (controller I) 180.

The first input unit 110 can include at least one operation button to allow the user to input desired commands. A user command signal input through the first input unit 110 is provided to the first controller 180, and the first controller 180 controls the printer 100 in response to the input user command signal.

For example, the first input unit 110 can input a residual recording material check command to the first controller 180.

The first display unit 120 displays user notification messages in response to a user command or under the control of the first controller 180.

Under the control of the first controller 180, the first display unit 120 displays a normal refill request message and/or an abnormal refill notification message. Here, the normal refill request message is a message that encourages the user to use an authenticated recording material for a refill since the recording material in the current recording material storage medium 160, although the residual amount of the recording material therein is greater than the predetermined threshold, has been refilled abnormally (i.e., a non-authenticated product has been used as the recording material). The abnormal refill notification message is a message that reminds the user that the recording material is being refilled abnormally (i.e., the non-authenticated recording material is being used for the refill) even though the residual amount of the recording material therein is greater than the predetermined threshold. Accordingly, various messages can be displayed by the first display unit 120 according to various embodiments of the present general inventive concept.

Under the control of the first controller 180, the first volatile memory 130 temporarily stores data generated during operations of the printer 100.

The first non-volatile memory 140 stores control programs to control general operations of the printer 100.

The print engine 150 prints a printing document (i.e., a document to be printed), under the control of the first controller 180. That is, the first controller 180 controls the print engine 150 to execute a printing operation using the recording material stored in the storage 163 of the recording material storage medium 160.

As illustrated in FIGS. 1 and 2, the recording material storage medium 160 includes the storage 163 and the CRUM 165.

Under the control of the first controller 180, the residual recording material checking unit 170 checks the quantity of the recording material remaining in the storage 163 of the recording material storage medium 160 at regular intervals. The first controller 180 can control the residual recording material checking unit 170 to move to a position close to the storage 163 of the recording material storage medium 160 at the regular intervals to check the quantity of the recording material remaining in the storage 163. The residual recording material checking unit 170 can communicate with the recording material storage medium 160 through a wire contact or a wireless method.

The first controller 180 controls and manages the general operations of the printer 100 according to the control programs stored in the first non-volatile memory 140.

The first controller 180 also controls the CRUM 165 to store information regarding the quantity of the recording material remaining in the storage 163 provided from the residual recording material checking unit 170. The first controller 180 can control the CRUM 165 to store the information regarding the quantity of the recording material remaining in the storage 163 at predetermined time intervals. For example, the CRUM 165 can store the information regarding the quantity of the recording material remaining in the storage 163 every day.

When the residual recording material check command is input, the first controller 180 can read out the information regarding the quantity of the recording material remaining in the storage 163 from the CRUM 165. Additionally, the first controller 180 can read out the information regarding the quantity of the recording material remaining in the storage 163 from the CRUM 165 at predetermined time intervals.

The first controller 180 determines whether the quantity of the recording material remaining in the storage 163 is greater than the predetermined threshold based on the read out information regarding the quantity of the recording material remaining in the storage 163.

If the quantity of the recording material remaining in the storage 163 is not greater than the predetermined threshold, the first controller 180 sets the toner shortage indicator stored in the predetermined storage of the CRUM 165 to “Low”.

On the other hand, if the quantity of the recording material remaining in the storage 163 is greater than the predetermined threshold, the first controller 180 determines whether the toner shortage indicator is currently set to “Low”.

If the toner shortage indicator is set to “Low”, even though the quantity of the recording material remaining in the storage 163 is greater than the predetermined threshold, the first controller 180 determines that the recording material storage medium 160 has been refilled by an abnormal (i.e., non-authentic) method. Accordingly, the first controller 180 can generate the normal refill request message and control the first display unit 120 to display the normal refill request message. The first controller 180 can store information reflecting that the recording material is refilled by an abnormal (i.e., non-authentic) method in the CRUM 165.

If the toner shortage indicator is not set to “Low” when the quantity of the recording material remaining in the storage 163 is greater than the predetermined threshold, the first controller 180 determines that the recording material storage medium 160 has been refilled by a normal (i.e., authentic) method. That is, when the recording material has been used to refill the recording material storage medium 160 by the authentic method using the recording material refill device 200 of FIG. 1, the second controller 250 of the recording material refill device 200 initiates the toner shortage indicator such that the toner shortage indicator is no longer set to “Low”. Accordingly, when the toner shortage indicator is not set to “Low”, the recording material has been refilled by the authentic method.

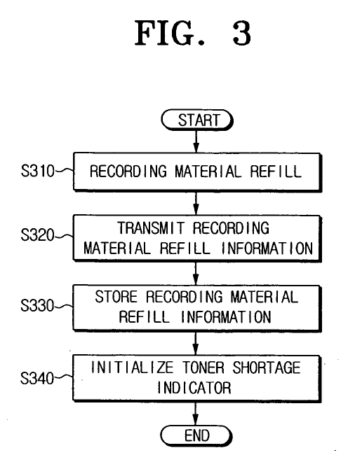

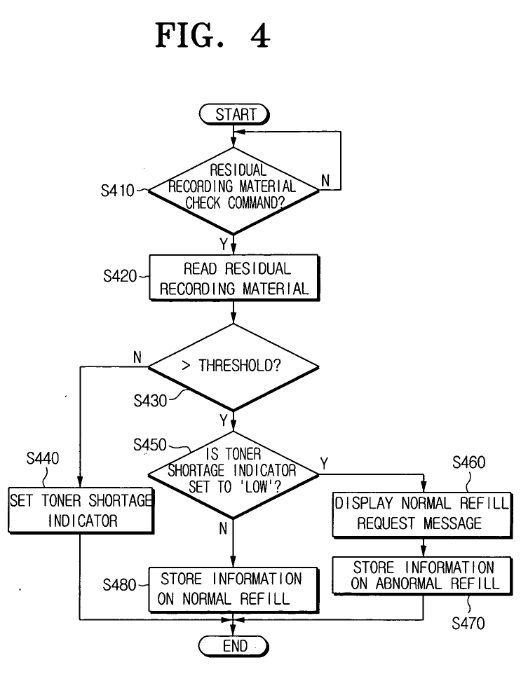

FIG. 3 is a flow chart illustrating a method of storing the recording material refill information according to an embodiment of the present general inventive concept.

Referring to FIGS. 1 and 3, the storage 163 of the recording material storage medium 160 is refilled with the recording material through the recording material refill device 200 available at an authenticated (cartridge) refill station or personally purchased by the user (S310).

When the refilling process is over, the recording material refill device 200 can automatically generate and transmit the recording material refill information (S320). Alternatively, the recording material refill information can be input manually through the second input unit 210 of the recording material refill device 200 and then transmitted to the CRUM 165.

The transmitted recording material refill information is stored in the CRUM 165 (S330).

The toner shortage indicator stored in the CRUM 165 is then initialized by the recording material refill device 200 (S340).

FIG. 4 is a flow chart illustrating a method of managing the recording material refill information according to an embodiment of the present general inventive concept.

Referring to FIGS. 1, 2, and 4, when the residual recording material check command is input through the first input unit 110 (S410), the first controller 180 controls the residual recording material checking unit 170 to check the quantity of the recording material remaining in the storage 163. The first controller 180 then reads out the information regarding the quantity of the recording material remaining in the storage 163 from the CRUM 165 (S420). The information regarding the quantity of the recording material remaining in the storage 163 can also be read and checked at predetermined time intervals, under the control of the first controller 180.

The first controller 180 then determines whether the quantity of the recording material remaining in the storage 163 is greater than the predetermined threshold (S430). If the quantity of the recording material remaining in the storage 163 is not greater than the predetermined threshold at operation S430, the first controller 180 sets the toner shortage indicator stored in the predetermined storage of the CRUM 165 to “Low” (S440).

On the other hand, if the quantity of the recording material remaining in the storage 163 is greater than the predetermined threshold at operation S430, the first controller 180 determines whether the toner shortage indicator is currently set to “Low” (S450).

If the toner shortage indicator is determined to be set to “Low” at operation S450, the normal refill request message can be generated by the first controller 180 and displayed on the first display unit 120 (S460). The normal refill request message indicates that a non-authenticated recording material has been used to refill the storage 163, i.e., the storage 163 is refilled by a non-authentic method. The information reflecting that the recording material is used by the non-authentic method to refill the storage 163 is then stored in the CRUM 165 under the control of the first controller 180 (S470). At operation S460, at least one of the normal refill request message and the abnormal refill notification message can be displayed.

If the toner shortage indicator is determined to be set to “Low” at operation S450, the first controller 180 determines that the recording material storage medium 160 has been refilled using an authentic recording material by the authentic method and stores information regarding the normal refill in the CRUM 165 (S480).

The present general inventive concept may be embodied in hardware, software, or a combination thereof. For example, the present general inventive concept may be embodied by a computer running a program from a computer-readable medium, including but not limited to storage media such as magnetic storage media (ROMs, RAMs, floppy disks, magnetic tapes, etc.), optically readable media (CD-ROMs, DVDs, etc.), and carrier waves (transmission over the internet). The present general inventive concept may be embodied as a computer-readable medium having a computer-readable program code to cause a number of computer systems connected via a network to effect distributed processing.

As described above, in an image forming device and a controlling method thereof according to the embodiments of the present general inventive concept, information about a recording material refill process is stored in a CRUM of a recording material storage medium such that a user can effectively manage the recording material storage medium and any (technical) troubles in the image forming device. Also, a toner shortage indicator stored in the CRUM determines whether the recording material has been refilled by an authentic method or by a non-authentic method, thereby encouraging the user to use the authentic method for refills. Furthermore, if the image forming device gets out of order because of the use of a non-authenticated (e.g., poor quality) recording material, repairing charges thereof may increase which can also motivate the user to user the authentic method for cartridge refills. Accordingly, the toner shortage indicator can help a user quickly find out a cause of a breakdown of the image forming device and print defects. Therefore a user is encouraged to use an authentic recording material for refills to get optimum print quality.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming device to form an image using a recording material stored in a recording material storage medium, the device comprising:
a customer replaceable unit memory (CRUM) provided to the recording material storage medium to store a toner shortage indicator that is set to “Low” to indicate a recording material shortage if a remaining quantity of the recording material in the recording material storage medium is not greater than a predetermined threshold; and
a controller to determine that the recording material storage medium is refilled with the recording material by a non-authentic method if the remaining quantity of the recording material in the recording material storage medium is greater than the predetermined threshold and the toner shortage indicator is set to “Low” to indicate the recording material shortage.

2. The device according to claim 1, wherein the controller controls information regarding a non-authentic refill to be stored in the CRUM when the controller determines that the recording material storage medium is refilled by the non-authentic method.

3. The device according to claim 1, further comprising:
a residual recording material checking unit to check the remaining quantity of the recording material in the recording material storage medium, wherein the controller controls information regarding the remaining quantity of the recording material to be stored in the CRUM based on the checking result.

4. The device according to claim 3, further comprising:
an input unit to input a residual recording material check command, wherein when the residual recording material check command is input, the controller reads the information regarding the remaining quantity of the recording material from the CRUM.

5. The device according to claim 3, wherein the controller reads the information regarding the remaining quantity of the recording material from the CRUM at predetermined time intervals.

6. The device according to claim 1, further comprising:
a display unit, wherein if the toner shortage indicator is set to “Low” to indicate the recording material shortage and the remaining quantity of the recording material in the recording material storage medium is greater than the predetermined threshold, the controller controls at least one of a normal refill request message and an abnormal refill notification message to be displayed on the first display unit.

7. An image forming device, comprising:
a refillable recording material storage medium to store a recording material and having a customer replaceable unit memory (CRUM) to store an amount of the recording material remaining in the recording material storage medium and an indicator to indicate a shortage in the amount of the recording material remaining in the storage medium; and
an authenticity determination unit to determine whether the recording material storage medium has been refilled using an authentic process based on the amount of the recording material in the recording material storage medium and the indicator.

8. The image forming device according to claim 7, wherein the authenticity determination unit comprises:
a residual recording material checking unit to check the amount of the recording material remaining in the recording material storage medium and to store the checked amount of the recording material stored in the recording material storage medium in the CRUM.

9. The image forming device according to claim 7, wherein the authenticity determination unit determines that the recording material storage medium has been refilled using the authentic process when the amount of the recording material remaining in the recording material storage medium is consistent with a state of the indicator, and determines that the recording material storage medium has been refilled using a non-authentic process when the amount of the recording material remaining in the recording material storage medium is inconsistent consistent with the state of the indicator.

10. A recording material storage medium refillable with a recording material through a recording material refill device after a pre-stored recording material is exhausted, comprising:
a storage to store the recording material; and
a customer replaceable unit memory (CRUM) to store recording material refill information about the recording material refilling process.

11. The recording material storage medium according to claim 10, wherein the recording material refill information comprises at least one of a refill count, a refill date, an amount of the refilled recording material, a product name of the refilled recording material, a product ID of the refilled recording material, a refill station ID (if the refilling process is executed at a recording material refill station), and an engineer ID at the refill station.

12. The recording material storage medium according to claim 10, wherein the CRUM further stores a toner shortage indicator that is set to “Low” if a residual amount of the recording material is less than a predetermined threshold, and a time and a date of checking the toner shortage, wherein the recording material refill device initializes the toner shortage indicator such that the toner shortage indicator is no longer set to “Low” when the recording material refilling process is completed.

13. A refillable recording material storage medium usable with an image forming device to store a recording material, comprising:
a customer replaceable unit memory (CRUM) to store a recording material shortage indicator to indicate a shortage of the recording material in the recording material storage medium and to be reset when the recording material storage medium is refilled using an authentic method.

14. A recording material refill device to refill a recording material storage medium with a recording material, comprising:
a recording material refill management program to generate recording material refill data;
an interface to transmit the recording material refill data to the recording material storage medium to be stored in a customer replaceable unit memory (CRUM) of the recording material storage medium; and
a controller to reset a recording material shortage indicator stored in the CRUM such that the recording material shortage indicator no longer indicates a shortage of the recording material in the recording material storage medium.

15. The recording material refill device according to claim 14, wherein the recording material refill management program automatically generates the recording material refill data when the recording material storage medium is refilled with the recording material.

16. The recording material refill device according to claim 14, wherein the recording material refill management program generates a graphic user interface to allow a user to input the recording material refill data.

17. An image forming system comprising:
a recording material storage medium having a storage to store a recording material and a customer replaceable unit memory (CRUM) to store information regarding a refill process and an indicator to indicate a shortage of the recording material stored in the storage;
a recording material refill device to refill the storage of the recording material storage medium with the recording material, to transmit the information regarding the refill process to the CRUM of the recording material storage medium, and to reset the indicator when the storage is refilled; and
an image forming device to accommodate the recording material storage medium therein, to form an image using the recording material stored in the storage of the recording material storage medium, and having a controller to determine whether the storage has been refilled using an authentic process according to the indicator and an amount of the recording material in the recording material storage medium.

18. A controlling method of an image forming device using a recording material stored in a recording material storage medium, the method comprising:
checking a residual amount of the recording material in the recording material storage medium;
if the residual amount of the recording material is greater than a predetermined threshold, determining whether a toner shortage indicator stored in a customer replaceable unit memory (CRUM) of the recording material storage medium is set to “Low” to indicate a recording material shortage; and
if the toner shortage indicator is set to “Low” to indicate the recording material shortage and the residual amount of the recording material is greater than the predetermined threshold, determining that the recording material storage medium is refilled with the recording material by a non-authentic method.

19. The method according to claim 18, further comprising:
storing information regarding the checked residual amount of the recording material in the CRUM.

20. The method according to claim 19, further comprising:
if the toner shortage indicator is set to “Low” to indicate the recording material shortage and the residual amount of the recording material is greater than the predetermined threshold, displaying at least one of a normal refill request message and an abnormal refill notification message.

21. The method according to claim 18, further comprising:
if the residual amount of the recording material is not greater than the predetermined threshold, setting the toner shortage indicator to “Low”.

22. The method according to claim 18, further comprising:
if the toner shortage indicator is not set to “Low” to indicate the recording material shortage and the residual amount of the recording material is greater than the predetermined threshold, determining that the recording material in the recording material storage medium is refilled by an authentic method.

23. A method of controlling an image forming device, comprising:
storing information regarding an amount of recording material remaining in a recording material storage medium of the image forming device in a customer replaceable unit memory (CRUM); and
determining whether the recording material storage medium has been refilled using an authentic process based on the stored information regarding the amount of the recording material remaining in the recording material storage medium and a recording material shortage indicator stored in the CRUM.

24. The method according to claim 23, wherein the determining of whether the recording material storage medium has been refilled using the authentic process comprises:
determining that the recording material storage medium has been refilled using the authentic process when the amount of the recording material remaining in the recording material storage medium is greater than a predetermined threshold and the recording material shortage indicator does not indicate a shortage of the recording material; and
determining that the recording material storage medium has been refilled using a non-authentic process when the amount of the recording material remaining in the recording material storage medium is greater than the predetermined threshold and the recording material shortage indicator indicates the shortage of the recording material.

25. The method according to claim 24, further comprising:
controlling the recording material shortage indicator to indicate the shortage of the recording material when the amount of the recording material remaining in the recording material storage medium is not greater than the predetermined threshold.

26. A method of refilling a recording material storage medium usable with an image forming device, the method comprising:
filling a storage area of the recording material storage medium with a recording material;
transmitting recording material refill information to the recording material storage medium to be stored in a customer replaceable unit memory (CRUM) of the recording material storage medium; and
initializing a recording material shortage indicator stored in the CRUM such the recording material shortage indicator does no longer indicates a shortage of the recording material in the recording material storage medium.

27. A computer readable recording medium having executable codes to perform a controlling method of an image forming device using a recording material stored in a recording material storage medium, the method comprising:
checking a residual amount of the recording material in the recording material storage medium;
if the residual amount of the recording material is greater than a predetermined threshold, determining whether a toner shortage indicator stored in a customer replaceable unit memory (CRUM) of the recording material storage medium is set to “Low” to indicate a recording material shortage; and
if the toner shortage indicator is set to “Low” to indicate the recording material shortage and the residual amount of the recording material is greater than the predetermined threshold, determining that the recording material in the recording material storage medium is refilled by a non-authentic method.

28. A computer readable recording medium having executable codes to perform a method of controlling an image forming device, comprising:
storing information regarding an amount of recording material remaining in a recording material storage medium of the image forming device in a customer replaceable unit memory (CRUM); and
determining whether the recording material storage medium has been refilled using an authentic process based on the stored information regarding the amount of the recording material remaining in the recording material storage medium and a recording material shortage indicator stored in the CRUM.

29. A computer readable recording medium having executable codes to perform a method of refilling a recording material storage medium usable with an image forming device, the method comprising:
filling a storage area of the recording material storage medium with a recording material;
transmitting recording material refill information to the recording material storage medium to be stored in a customer replaceable unit memory (CRUM) of the recording material storage medium; and
initializing a recording material shortage indicator stored in the CRUM such the recording material shortage indicator does no longer indicates a shortage of the recording material in the recording material storage medium.
